(19) United States
(12) Patent Application Publication
(10) Pub. No.: US 2005/0005493 A1
(43) Pub. Date: Jan. 13, 2005

(54) Display holder for mounting items on fabric or non-woven fibrous surfaces

(76) Inventor: Paul E. Chasnoff, Evanston, IL (US)

Correspondence Address: David C. Brezina, Lee, Mann, Smith,;McWilliams, Sweeney & Ohlson, P.O. Box 2786, Chicago, IL, 60690-2786, US

(21) Appl. No.: 10/910,936

(22) Filed: Aug. 4, 2004

Related U.S. Application Data
(63) Continuation of application No. 10/142,691, filed on May 9, 2002, now Pat. No. 6,789,340.
(60) Provisional application No. 60/290,398, filed on May 11, 2001.

(51) Int. Cl. G09F 3/18; G09F 7/12

(52) U.S. Cl. 40/661; 40/594

(57) ABSTRACT

A display device for flat surfaces preserves the integrity of both the display item and the mounting surface by enabling the placing the display item in the polypropylene pocket., thereby eliminating the need to tape or tack the display item to the mounting surface and either pierce the display item with a tack or remove a portion of the display item when removing the tape, and similarly, the integrity of the mounting surface is preserved because the attachment member simply grabs on to the surface, instead of being pierced by a tack or taped.

### CLAIM OF PRIORITY

Priority is claimed based on U.S. Provisional Application Ser. No. Ser. No. 60/290,398, filed May 11, 2001 invented by Paul E. Chasnoff.

### BACKGROUND OF THE INVENTION

This invention relates to a flat surface display item on a fabric or non-woven fibrous surface. The essence of this invention is the polypropylene pouch together with the hook system on the back side. Together the pouch and the hook system create a protective display that protects the insert as well as the fabric or non-woven fibrous surface. The polypropylene pouch preserves the integrity, and ensures the archivability, of the insert.

1. Field of the Invention

The present invention relates to improved mounting and display of a flat surfaced item on fabric or non-woven fibrous surfaces.

2. Description of Related Art

Presently, if one wants to post a picture or other flat surfaced item on the wall of their cubicle they either need to use a push pin, or an adhesive such as tape. Often this leads to damaging the flat-surfaced item or the fabric or non-woven fibrous surfaces. This invention improves over this practice by using a micro-hook system on the back of a polypropylene pouch whereby the displayed item is safe and clearly viewable and the fabric or non-woven fibrous surface is preserved.

### BRIEF DESCRIPTION OF THE PREFERRED EMBODIMENT

The display holder for mounting items on fabric or non-woven fibrous surfaces is designed to be a convenient and inexpensive method mounting display items in one's workspace. The preferred embodiment of this product consists of two polypropylene sheets laminated together to form a display pocket. At least one attachment member is laminated to one side of the display pocket. The attachment member contains a plurality of micro-hooks that allow the display device to easily and safely attach to fabric or non-woven fiberous material.

### BRIEF DESCRIPTION OF THE DRAWINGS

FIG. 1 is a front view of the display holder for mounting items on fabric or non-woven fibrous surfaces.

FIG. 2 is a front view of the attachment member.

FIG. 3 is a side view of the attachment member.

FIG. 4 is a top view of the display holder for mounting items on fabric or non-woven fibrous surfaces with the attachment member.

FIG. 5 is a perspective view of the display pocket.

### DETAILED DESCRIPTION OF THE PREFERRED EMBODIMENT

For the purpose of promoting an understanding of the principles of the invention, references will be made to the embodiments illustrated in the drawings. It will, nevertheless, be understood that no limitation of the scope of the invention is thereby intended, such alterations and further modifications in the illustrated device, and such further applications of the principles of the invention illustrated herein being contemplated as would normally occur to one skilled in the art to which the invention relates.

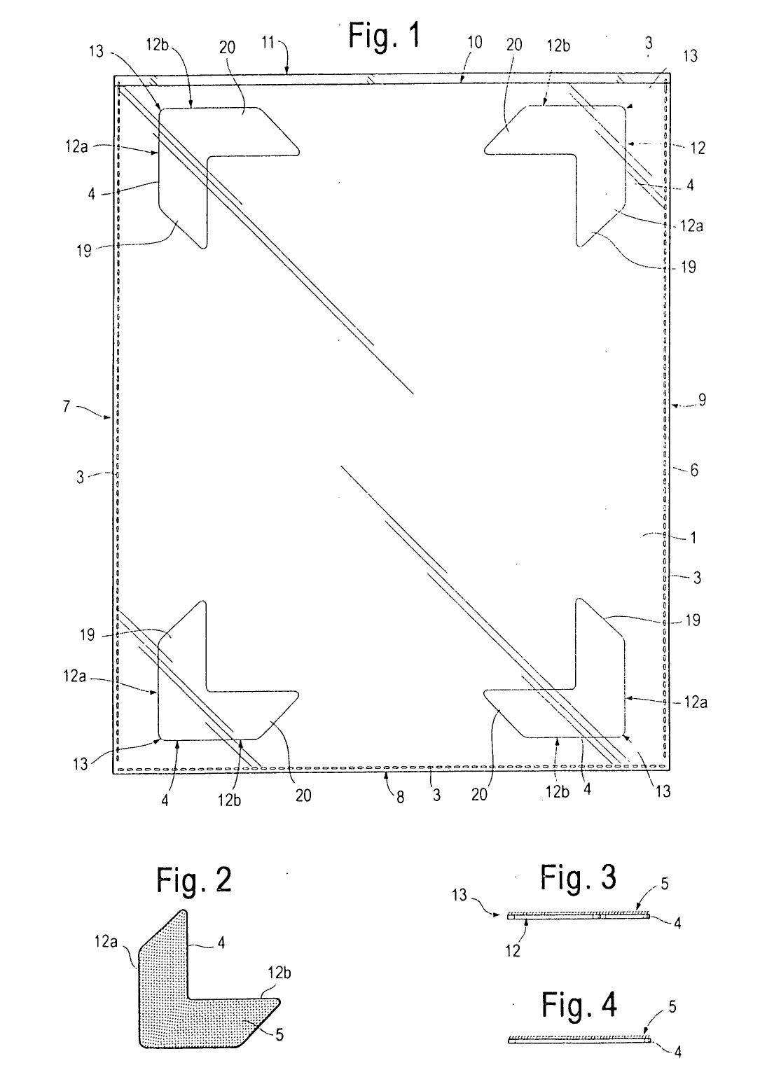

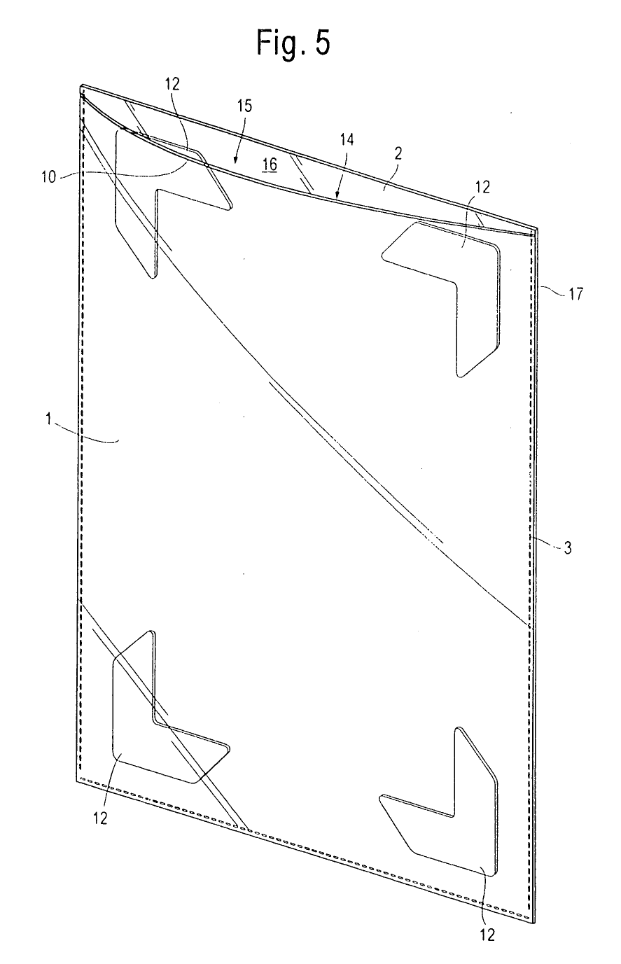

A preferred embodiment of the display device 6 of the present invention is shown in FIG. 1. The display device 6 is adapted to attach to a fabric or non-woven fiberous material without damaging the display item or material. Also, in the preferred embodiment the display device 6 is made of polypropylene sheet material. The benefits of polypropylene include, but are not limited to, better archivability of a display item. Additionally, a preferred embodiment of the display device 6 uses a non-glare polypropylene. The non-glare polypropylene aids in the viewing of the display item.

Other material can be used provided it has the properties of being a foldable clear or matte material such that an object can be easily viewed from within the display device. The material is preferable capable of being thermally bonded. Additionally, the material may be smooth or textured, as adhesives certain adhesives may perform better on textured surfaces.

The display device 6 is comprised of a polypropylene display pocket 14, which consists of a top polypropylene sheet 1 and a bottom polypropylene sheet 2.

Top or first sheet 1 has left and right edges 7 and 9 and bottom edge 8. The forming of and bonding of sheets 1 and 2 are attached about edges 7, 8, 9 by various means including heat sealing, ultrasonic welding, stitch welding, or gluing, create the display pocket 14. As described above, thermal or heat sealing or welding is preferred. Sheet 1 also has a top edge 10 which is unbonded and provides a slot 15 for pocket 14. The terms ‘top’ and ‘bottom’ as used herein are relative to the figures shown.

The bottom or second polypropylene sheet 2 has a top edge 11 that extends past top edge 10 of the first polypropylene sheet 1. The extension of edge 11 of the second polypropylene sheet 2 past edge 11 of the first polypropylene sheet 1 allows for easier insertion and removal of a displayed item from the display pocket 14 through slot 15.

Sheet 2 has a front surface 16 to which sheet 1 is actually bonded, and a rear surface 17, which contacts the fabric or non-woven surface and receives fastening members 5.

An attachment member 4 consists of a exterior surface 13 and an interior surface 12. The exterior surface 13 of the attachment member 4 contains a plurality of gripping members 5 to engage the fabric or non-woven fibrous material.

This gripping member 5 may be a micro-hook, which consists of tiny plastic hooks, similar to the hooks of the hook and loop method commonly known as Velcro, a barb, a mushroom shape, or any other shape that will sufficiently grab the fabric or fibrous non-woven material. Typical is the preferred HTH 29 hook available from Velcro USA, Inc. of 406 Brown Avenue, Manchester, N.H., 03103. The hooks attach the the fibers of the surface, whether the fibers are woven to comprise a fabric, or the fibers that are formed into the non-woven fibrous material. The term “material” without further limitation refers to both the fabric material and the non-woven material.

The typical material to which the device is releasably affixed is that used as a liner or other decorative and/or sound absorbing material which is familiar to one of ordinary skill in office arrangements and applied to partitions used to divide areas and separate employees in a typical large office environment. Other similar materials can be used as a decorative wall covering applied to walls or as a wall hanging.

In the preferred embodiment, the gripping member 5 is made of plastic, however, other material may be used as long as it is malleable and strong enough to support the weight of the display device with its contained display item, and to enable removal without damage to the fabric or non-woven material described. The bottom 12 of the attachment member is attached to a polypropylene sheet by various means including laminating, heat seal, stitch weld, and glue.

In the preferred embodiment, the attachment member 5 is chevron shaped with the vertical legs 12a of the chevron placed aligned with sides 7 or 9 and the horizontal legs 12b placed aligned with bottom 8 or top 10 edge of the display device 6. The members 5 are further aligned such that the apex 13 of the chevron is pointing in the corner where the respective edges meet. Locating members 5 at the corners and using the chevron configuration further assists in maintaining sheets 1 and 2 in a generally coplanar position. This provides improved viewability and avoids sagging, particularly of sheet 1, thereby providing improved optical properties desirable when display device 6 is supporting an item such as a photograph. It will also be noted that the members in the location below slot 15 will, when pocket 14 is filled with a full size item, be concealed from view and a more pleasing appearance provided than if flanges or tabs outside the dimensions of the pocket 14 were used.

While other shapes of members 5 can provide adequate support, the chevron shape has been determined to optimize holding ability, maximize coplanar relationship between sheets, yet provide ease of removal and greater economic efficiency while enabling the above mentioned hidden property when the pocket 14 is filled.

1. A display device having a transparent viewing window to display an article and being removably attachable to a fibrous material, the display device comprising:
a continuous one piece first polypropylene sheet, adapted to be positioned against the fibrous material, the first polypropylene sheet having a first side and a second side;
a plurality of fasteners, each having a plurality of micro-hooks to attach the display device to the fibrous material, the plurality of fasteners affixed to the first side of the first polypropylene sheet; and
a continuous one piece second polypropylene sheet having a first side and a second side, the first side of the second polypropylene sheet being positioned adjacent the second side of the first polypropylene sheet, the sheets heat sealed about three edges to form a pocket, the pocket having an opening formed along a fourth edge, adapted to permit the article to be positioned within the pocket.

2. A display device having a transparent viewing window to display an article and being removably attachable to a wall of fibrous material, the display device comprising:
a continuous one piece first polypropylene sheet adapted to be positioned against the fibrous material;
a plurality of fasteners connected to the first polypropylene sheet, the fasteners adapted to attach the display device to the fibrous material; and
a continuous one piece second polypropylene sheet substantially covering the first polypropylene sheet, the sheets heat sealed about three edges to form a pocket, the pocket having an opening about a fourth edge, the opening adapted to permit the article to be positioned within the pocket.

3. A display device having a transparent viewing window to display an article and being removably attachable to a planar fibrous surface, the display device comprising:
a flat planar fibrous surface;
a continuous one piece first polypropylene sheet adapted to be connected to and positioned in a co-planar orientation to the fibrous surface;
a plurality of fasteners connected to the first polypropylene sheet, the fasteners adapted to attach the display device to the fibrous surface; and
a continuous one piece second polypropylene sheet substantially covering and positioned in a co-planar orientation to the first polypropylene sheet, the sheets being heat sealed about three edges to form a pocket, the pocket having an opening about a fourth edge, the opening adapted to permit the article to be positioned within the pocket.
